(19) United States
(12) Patent Application Publication
(10) Pub. No.: US 2017/0151775 A1
(43) Pub. Date: Jun. 1, 2017

(54) METHOD OF CONTROLLING A DIGITAL PRINTER WITH FAILURE COMPENSATION

(71) Applicant: Océ-Technologies B.V., Venlo (NL)

(72) Inventors: Koen J. KLEIN KOERKAMP, Venlo (NL); Louis J.A.M. SOMERS, Venlo (NL); Reinier J. DANKERS, Venlo (NL)

(73) Assignee: Océ-Technologies B.V., Venlo (NL)

(21) Appl. No.: 15/353,982

(22) Filed: Nov. 17, 2016

(30) Foreign Application Priority Data
Dec. 1, 2015 (EP) 15197348.4

(51) Int. Cl. B41J 2/045

(52) U.S. Cl. CPC B41J 2/0451; B41J 2/04586

(57) ABSTRACT

A method of controlling a digital printer having a reciprocating print head with an array of printing elements, the printer being arranged to operate in a selected one of a plurality of print modes, the printer having a failure detection system arranged to detect malfunctioning printing elements and a failure compensation system arranged to compensate a malfunction of a printing element by activating another printing element, the method comprising the steps of:
a) establishing a list of print modes sorted by decreasing productivity;
b) selecting an initial print mode;
c) simulating a print operation in the currently selected print mode;
d) counting a number of incidents in which a malfunction of a printing element cannot be compensated;
e) if the count result is below a given threshold value: keep the selected print mode;
f) if not: select the next print mode in the list and repeat steps (c) to (f) for that print mode.

The invention relates to a method of controlling a digital printer having a print head with an array of printing elements, the print head being arranged to scan a recording medium in a main scanning direction, and the print head and the recording medium being arranged to be moved relative to one another in a sub-scanning direction normal to the main scanning direction, the printer being arranged to operate in a selected one of a plurality of print modes which differ in productivity due to differences in a pattern of scan passes in which the array of printing elements moves over the recording medium, the printer further having a failure detection system arranged to detect malfunctioning printing elements, and a failure compensation system arranged to compensate a malfunction of a printing element by activating at least one other printing element in the array.

U.S. Pat. No. 6,847,465 B1 discloses a method of controlling an ink jet printer of the type indicated above. The printing elements comprise nozzles from which droplets of ink are jetted out onto the recording medium. The control method comprises detecting a number of operating conditions of the printer and assigning quality attributes to these operating conditions, one of the operating conditions being the number of malfunctioning nozzles of the printer. The quality attributes are used for calculating an average quality score which permits to assess an achievable print quality for each print mode.

EP 1 013 453 A2 describes an example of a method for detecting nozzle failures in an ink jet print head in real time, i.e. while the printer is operating.

An example of a method of compensating nozzle failures, once they have been detected, is described in EP 1 593 516 B1.

It is an object of the invention to provide a method which permits to compensate nozzle failures and to achieve an acceptable quality of the printed image and at the same time to achieve a highest possible productivity of the print process.

In order to achieve this object, the method according to the invention comprises steps of:
a) establishing a list of print modes sorted by decreasing productivity;
b) selecting an initial print mode;
c) simulating a print operation in the currently selected print mode and counting a number of incidents in which a malfunction of a printing element cannot be compensated;
d) if the count result is below a given threshold value: keep the selected print mode;
e) if not: select the next print mode print the list and repeat steps (c) to (e) for that print mode.

By simulating the print process in the selected print mode, it is possible to predict the number of nozzle failures (or, more generally, failures of printing elements) that cannot be compensated, and if that number is inacceptably high, the simulation is repeated for another print mode which has a lower productivity but therefore offers a greater chance that more nozzle failures can be compensated. Thus, for any desired quality level, it is possible to go through the list and to identify a print mode which has the highest productivity while still being capable of complying with the quality requirements.

More specific optional features of the invention are indicated in the dependent claims.

In one embodiment, the simulation is based on the positions of the malfunctioning nozzles in the array and on an analysis of the possibilities that, in the given print mode, the task of a failing nozzle can be taken over by one or more other nozzles, the analysis being based only on the position information on the nozzles and being independent of any image content of the image to be printed.

In other embodiments, the image information to be printed is also taken into account in the simulation. For example, it is possible to simulate a print process for a sample image which represents an image area with a given dot coverage, for example, the maximum dot coverage that occurs in an image to be printed. The likelihood that a nozzle failure can be compensated in the sample image and, consequently, also in an actual image to be printed increases with decreasing dot coverage, so that a print mode with higher productivity may be selected.

In another example, the simulation is made for the actual image to be printed, either for one or more selected areas in that image or for the entire image.

The initial print mode that is being selected in step (b) is preferably based on quality specifications that are input by the user. It will be observed that there is a trade-off between quality and productivity, so that a print mode with lower productivity will be selected as the initial print mode when the quality requirements are high.

The threshold value to which the number of non-compensated nozzle failures is compared in step (d) may be zero or any arbitrary number that is preferably determined as a function of the quality specification input by the user. It will be observed that the number of non-compensable nozzle failures may even be a non-integer. For example, there may be cases, depending on the failure compensation method being used, where a nozzle failure cannot be compensated completely but can only be camouflaged to a certain extent. Then, any number between 0 and 1 may be assigned to that incident, depending on the extent to which the nozzle failure can be camouflaged.

Similarly, the term “nozzle failure” or “malfunction of a printing element” is not limited to the case of a complete failure of the printing element but includes also cases where a dot that would have to be printed with the malfunctioning printing element is not missing completely but is slightly misplaced and/or does not have the correct size.

The invention is not limited to any specific method of nozzle failure compensation. In particular, it is not limited to the case that a task of a failing nozzle can fully be taken over by another nozzle, but it includes also strategies in which a loss in image density that is caused by a nozzle failure is compensated by increasing the image density in the neighborhood, e.g. by using an error diffusion algorithm.

In case of a multi-color printer, the method may be performed separately for each color. In another embodiment, the steps of the method according to the invention are performed jointly for all colors, which offers the possibility to consider also nozzle failure compensation strategies wherein a failure of a nozzle for one color is compensated by printing extra dots in one or more other colors.

When the number of malfunctioning nozzles increases, a point may be reached where the threshold value for the count of non-compensable nozzle failures is exceeded even for the last print mode in the list. Then, this last print mode may be selected because it can generally be expected that this print mode will be among those which offer the highest quality under the given circumstances. It is possible, however, that another print process that has been simulated earlier in the process had an even better result. Therefore, when the list of available print modes is exhausted, it is preferred that the print mode is selected from among the print modes that have been simulated, with the selection criterion that the number of non-compensable nozzle failures should be as small as possible.

Embodiment examples will now be described in conjunction with the drawings, wherein:

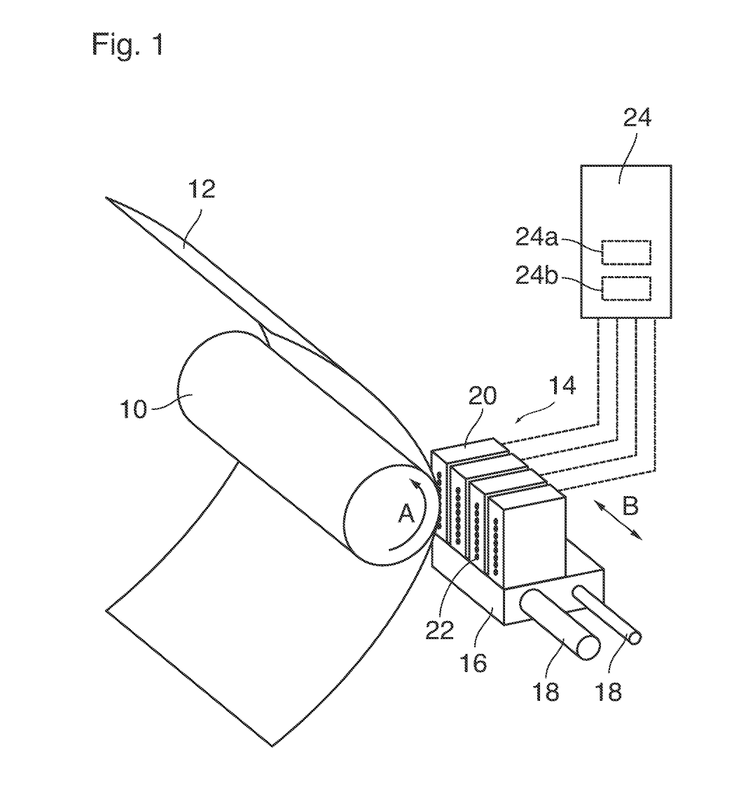

FIG. 1 is a schematic perspective view of an ink jet print head to which the invention is applicable;

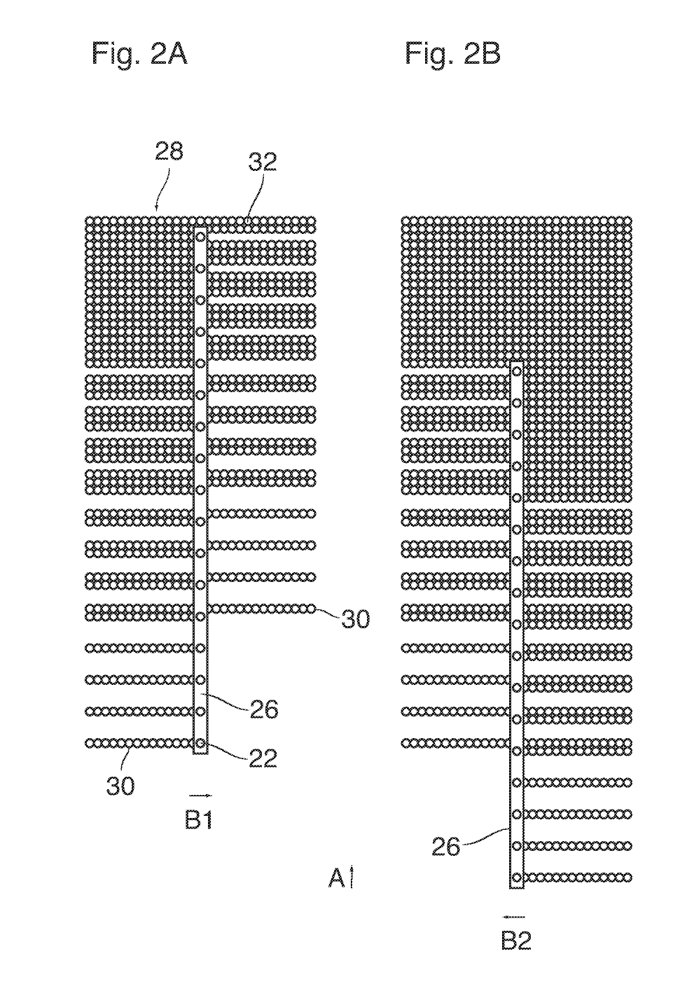

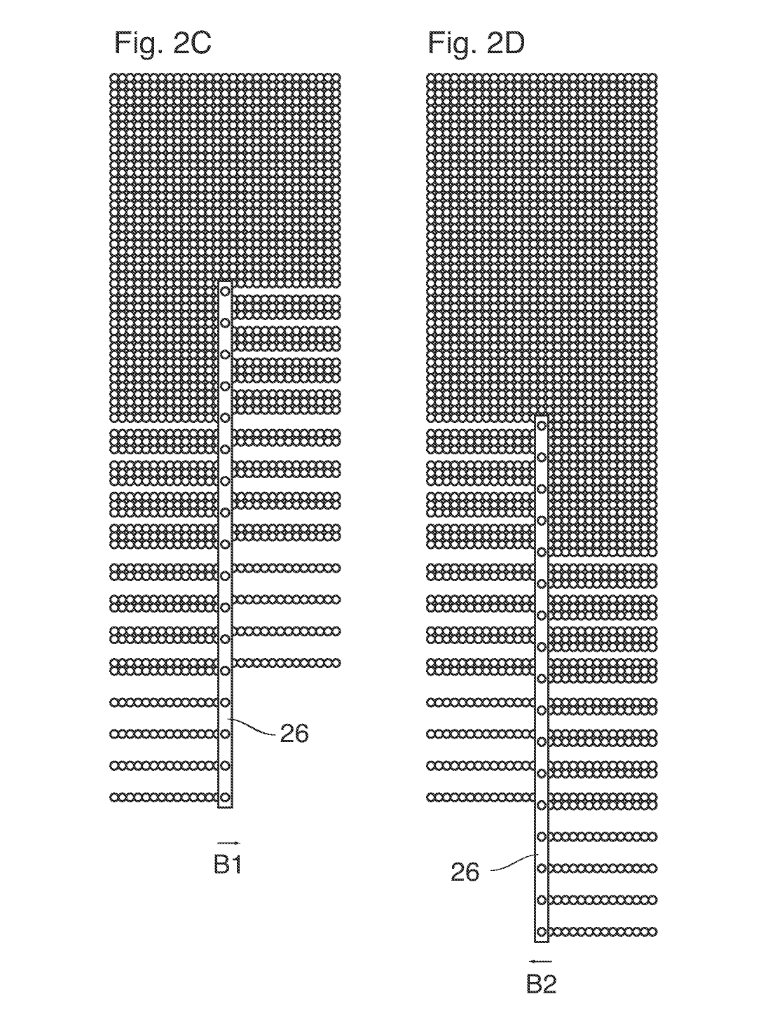

FIG. 2A-2D are diagrams illustrating a four-pass print mode;

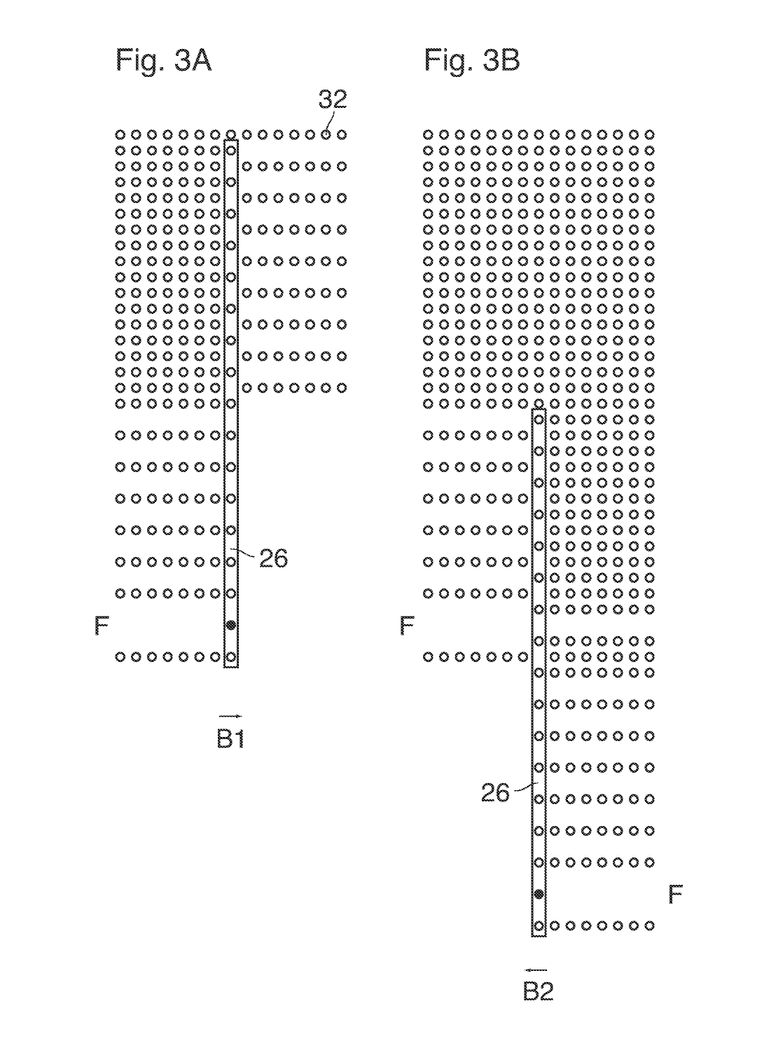

FIGS. 3A and 3B are diagrams illustrating a two-pass print mode with a print head in which one nozzle is failing;

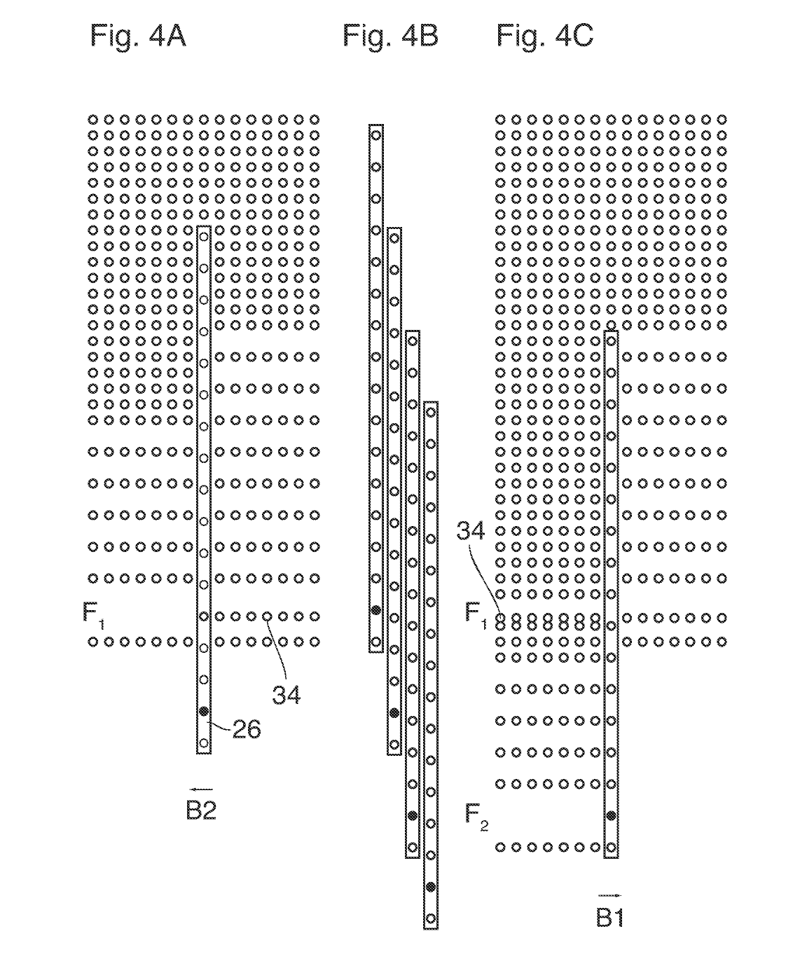

FIGS. 4A-4C are diagrams illustrating a four-pass print mode that is used for compensating the nozzle failure illustrated in FIGS. 3A and 3B;

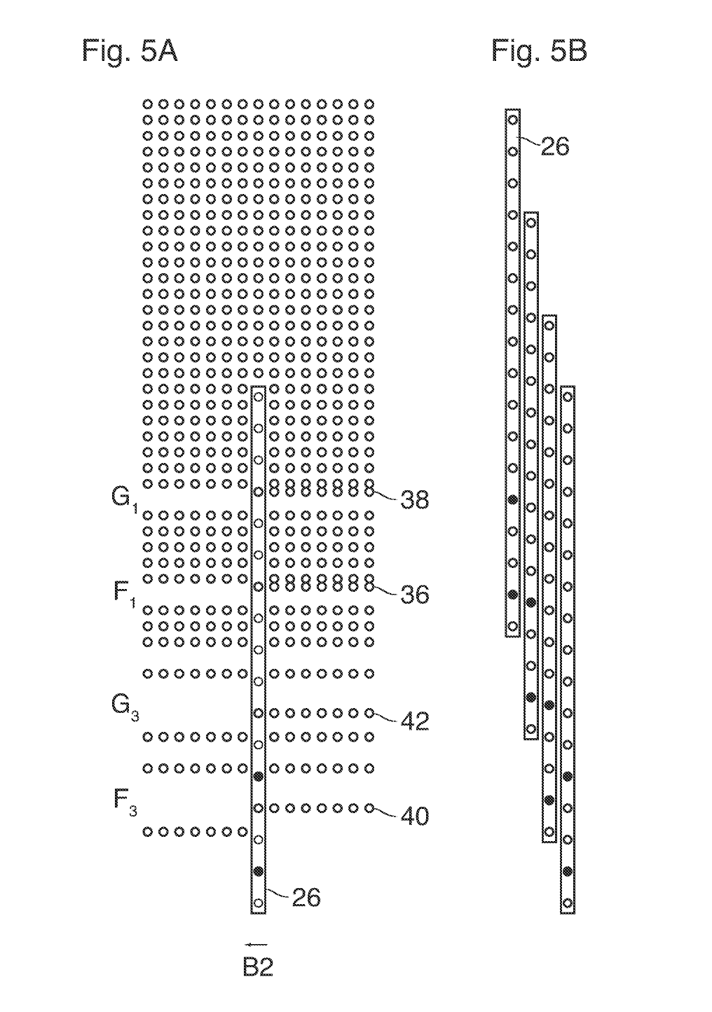

FIGS. 5A and 5B are diagrams illustrating a case in which two nozzles of the print head are failing;

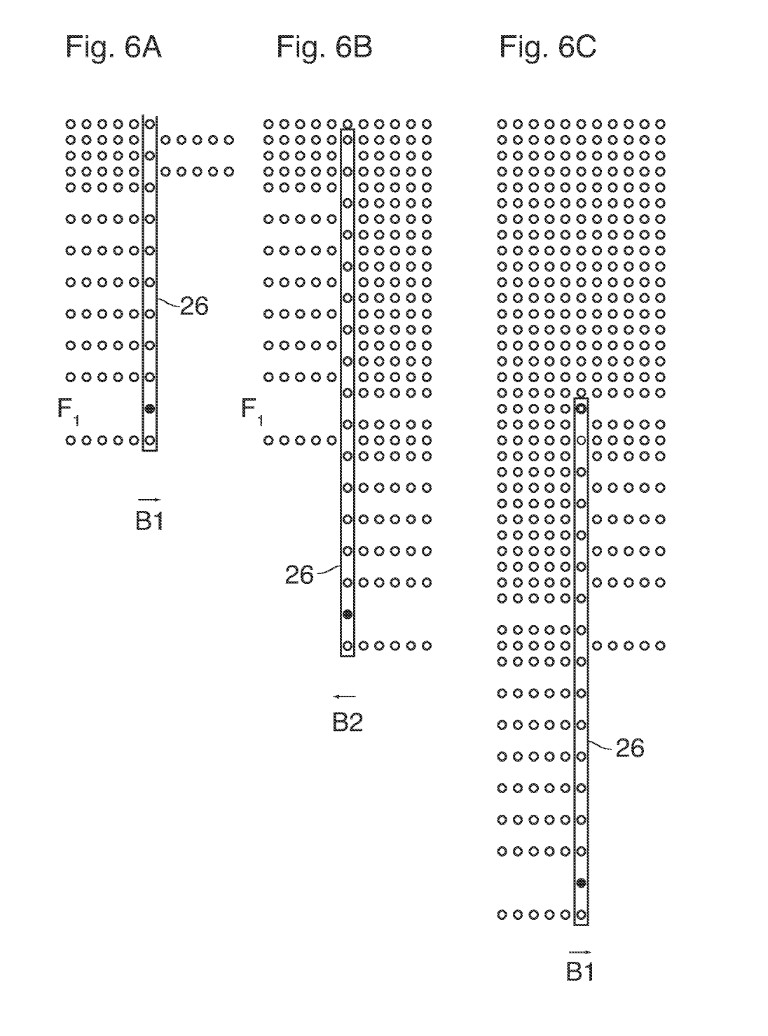

FIGS. 6A-6C are diagrams illustrating another print mode used for compensating a nozzle failure;

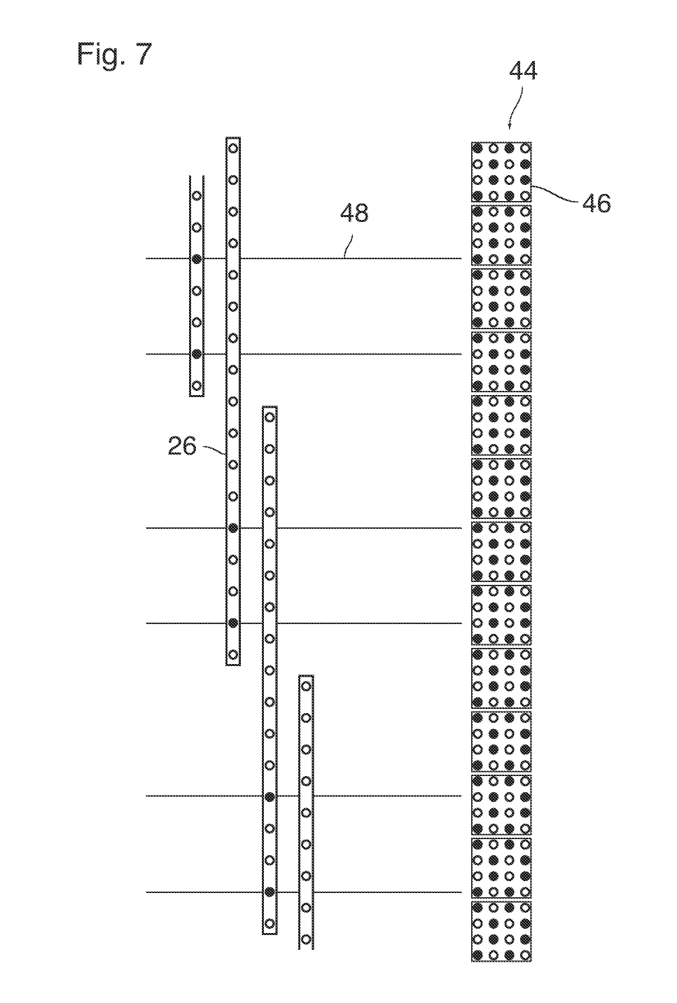

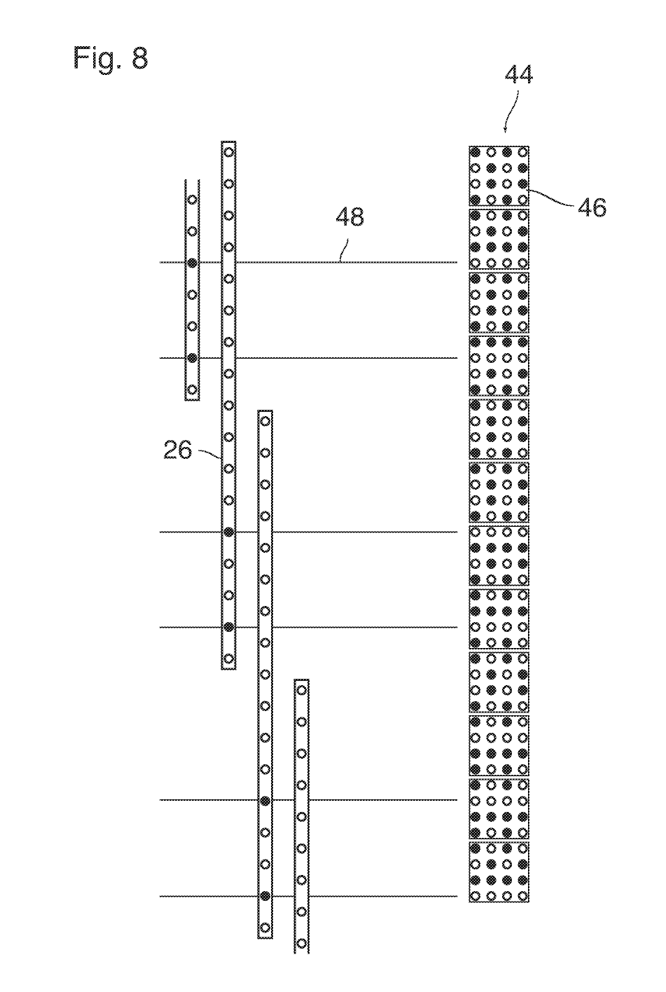

FIGS. 7 and 8 are diagrams illustrating a modified embodiment of the invention; and

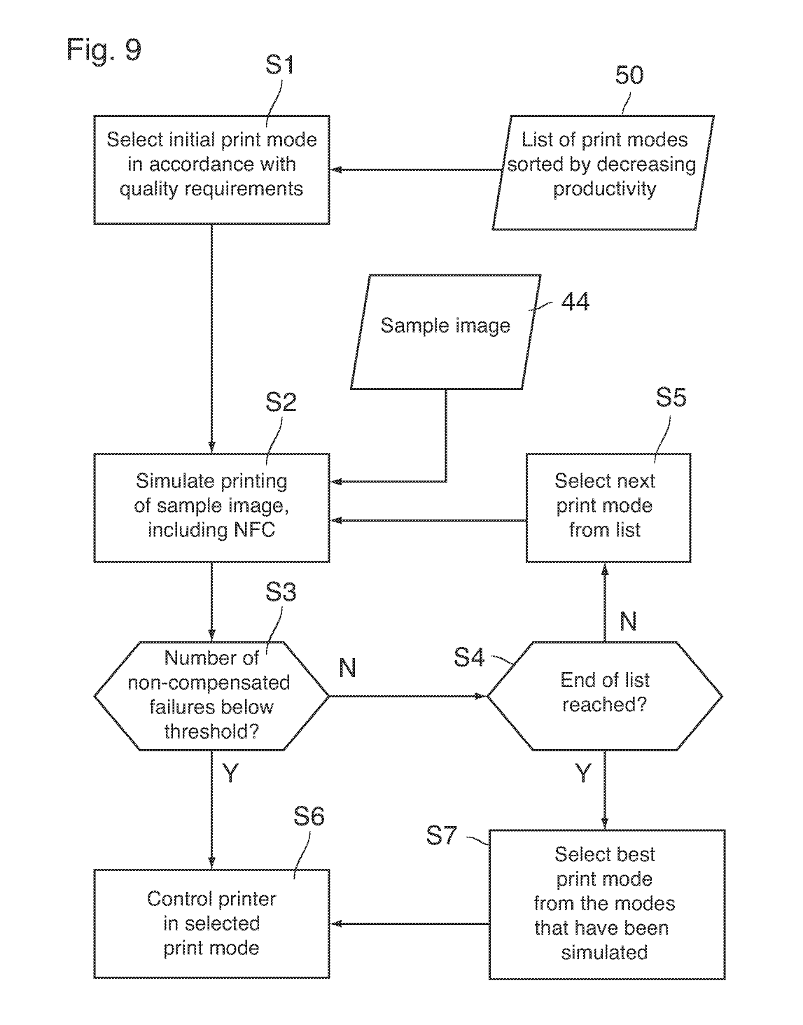

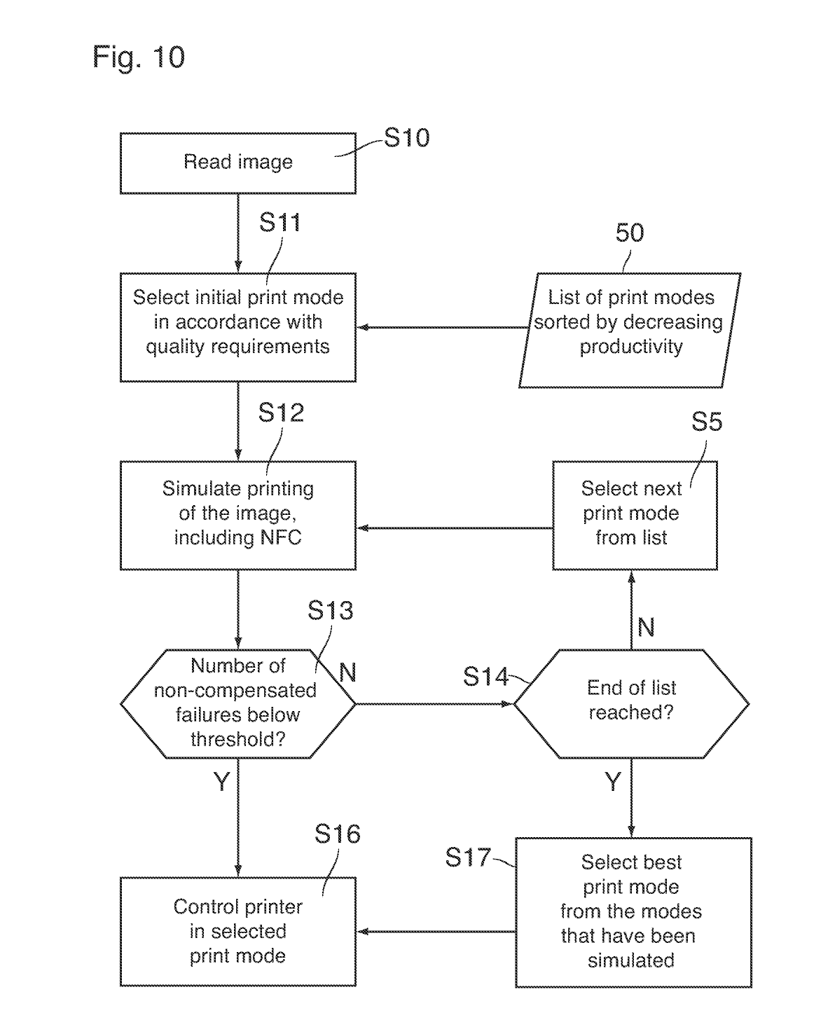

FIGS. 9 and 10 are flow diagrams for two different embodiments of the invention.

As is shown in FIG. 1, an ink jet printer comprises a platen 10 which serves for transporting a recording medium (paper) 12 in a sub-scanning direction (arrow A) past a print head unit 14. The print head unit 14 is mounted on a carriage 16 that is guided on guide rails 18 and is movable back and forth in a main scanning direction (arrow B) relative to the recording medium 12. In the example shown, the print head unit 14 comprises four print heads 20, one for each of the basic colors cyan, magenta, yellow and black. Each print head has a linear array of nozzles 22 (printing elements) extending in the sub-scanning direction. The nozzles 22 of the print heads 20 can be energized individually to eject ink droplets onto the recording medium 12, thereby to print a pixel on the paper. When the carriage 16 is moved in the direction B across the width of the recording medium 12, a swath of an image can be printed. The number of pixel lines of the swath corresponds to the number of nozzles 22 of each print head. When, in a single-pass print mode, the carriage 16 has completed one path, the recording medium 12 is advanced by the width of the swath, so that the next swath can be printed. In a multi-pass mode, the feed distance of the recording medium will be smaller than the width of the swath, and the pixels and pixel lines printed in different passes will be interleaved.

The print heads 20 are controlled by a processing unit 24 which processes the print data and generates control signals for controlling the printing elements in the print heads 20 as is well known in the art. The processing unit 24 includes also a detection system 24a for detecting nozzle failures, and a nozzle failure compensation system 24b for compensating nozzle failures

Different multi-pass print modes will now be described by reference to FIGS. 2 to 8. The discussion will be focused on printing in a single color, but is equivalently valid for printing in multiple colors.

FIGS. 2A-2D show a simplified example of a print head 26 with a linear array of (only) seventeen nozzles 22. Under the control of the processing unit 24, the nozzles 22 are fired periodically in order to print an image consisting of a solid image area 28 composed of parallel pixel lines 30. Each pixel line 30 is composed of ink dots 32. The ink dots 32 are printed in all pixel positions, so that the dots 32 in each line are placed directly adjacent to one another, and the individual pixel lines 30 are also directly adjacent to one another (at least in the respective top parts of the figures where the print process is completed), so that the image area 28 has a maximum dot coverage (of 100%).

It will be observed that the pitch of the nozzles 22 is four times the line distance of the pixel lines 30, so that a four-pass print mode is necessary for obtaining the maximum dot coverage.

FIG. 2A shows a scan pass in which the print head 26 moves from left to right (as indicated by an arrow B1). For the purpose of this description, the scan pass illustrated in FIG. 2A shall be designated as the “first pass”, although some of the pixel lines 30 in the top part of the image have been printed already in earlier cycles of the print process. The nozzles 22 shall be labeled by numbers 1-17 from the top to the bottom in the drawings. The nozzles No. 1 to No. 5 are just completing a swath with a width of seventeen pixel lines. The next four nozzles are printing a swath comprising four triplets of pixel lines, wherein the last line of each triplet is just being printed. The next four nozzles are printing a swath consisting of four pairs of pixel lines and the last four nozzles of the array are printing four separated pixel lines.

FIG. 2B illustrates the next pass (second pass) in which the print head 26 moves from right to left in the direction of an arrow B2. In a time interval between the first pass and the second pass, the recording medium 12 has been moved relative to the print head in the sub-scanning direction (arrow A) by a distance of seventeen pixel lines, equivalent to 8½ times the pitch of the nozzles, so that the nozzles No. 1 to No. 4 are now filling the gaps between the triplets of pixel lines that have been printed in the first pass, while the last four nozzles are printing a new swath with four separated pixel lines.

FIG. 2C illustrates a third pass in which the print head 26 moves again in the direction of the arrow B1, and FIG. 2D shows a fourth pass in which the print head moves again in the direction of arrow B2.

A swath (consisting of seventeen pixel lines in this example) of the solid image area 28 is completed as soon as the print head 26 has moved over that swath in four successive passes which constitute one print cycle.

The four pass mode illustrated in FIGS. 2A-2D offers the highest quality in terms of printing resolution, but does not permit any compensation of nozzle failures. Thus, when a nozzle fails, a gap in the form of a white pixel line will be left in each pass of the print head.

Of course, when the printer has a print head with two parallel rows of nozzles for each color, it is possible that, even in this highest-quality print mode, a nozzle failure in one row can be compensated by activating a nozzle in the other row, provided of course that the nozzle that is needed for the compensation does not fail itself. Similarly, it is possible that a nozzle failure in a print head for one color is compensated by printing an extra dot in another color.

FIGS. 3A and 3B illustrate a two-pass print mode in which the achievable print resolution is only one half of the resolution that was obtained in the four-pass mode. On the other hand, a swath of thirty-four pixel lines is completed already when the print head 26 has moved over that swath in only two successive passes (constituting one print cycle in this mode), so that the productivity is twice as high than in the mode shown in FIGS. 2A-2D. Consequently, the two-pass mode will be selected when the user does not require an extremely high quality (in terms of printing resolution) but wants to obtain the printed copy more quickly.

Four illustration purposes, the ink dots 32 in FIGS. 3A and 3B have been shown in the same size as the ink dots in FIGS. 2A-2D, so that in FIGS. 3A and 3B, the ink dots appear to be isolated from one another. In a practical embodiment, however, the size of the ink dots may be so large that they merge to form a solid area even in case of the two-pass mode.

In the example shown, the jetting frequency of the nozzles has also been reduced to one half, so that the image resolution has been reduced not only in the sub-scanning direction A but also in the main scanning direction.

FIGS. 3A and 3B illustrate the case that nozzle No. 16 fails, as has been symbolized by a black dot in the drawings. As a consequence, corresponding pixel lines are missing in the line positions that have been designated by F in FIGS. 3A and 3B. As long as the print mode is not changed, possibilities to compensate this nozzle failure are just as limited as in the case discussed above in conjunction with FIGS. 2A-2D.

However, it is possible to compensate for the nozzle failure by switching to a print mode with a lower productivity, e.g. to the four-pass mode discussed before. This has been illustrated in FIGS. 4A-4C.

FIG. 4A illustrates the second pass in which the print head 26 moves in the direction of arrow B2 and which corresponds to the pass that has been illustrated in FIG. 2B. Thus, in FIG. 4A, the first pass has been completed already but has left a gap in a line position F₁, due to the nozzle failure. In the second pass, almost all the nozzles of the print head 26 are silent, because the nozzle positions do not fit into the low-resolution pixel raster. Only the nozzle No. 13 is active (symbolized by a bolder contour of the nozzle) and prints an extra pixel line 34 to compensate for the missing line in the line position F.

FIG. 4B shows the relative positions of the print head 26 in the four successive scan passes, which facilitates to identify the pixel lines in FIGS. 4A and 4C with the nozzle positions.

FIG. 4C shows the third pass in which the print head moves again in the direction of arrow B1 for completing the printed image in the first three swathes. All nozzles of the print head are active, except for the failing nozzle No. 16, so that another gap where a pixel line is missing is created in line position F₂. In the line position F₁, the missing line is compensated for by the extra pixel line 34. Since this line had been printed in the second pass, the position of the line is offset from the intended position by one pixel. However, as long as the printing resolution is larger than the resolution of the human eye, this minor defect will generally remain unobserved. The missing line in line position F₂ will be compensated in a similar way in a subsequent scan pass, e.g. in the fourth pass.

FIGS. 5A and 5B illustrate the case that two nozzles of the print head 26, nozzle No. 13 and nozzle No. 16, are not operating. FIG. 5A shows the fourth pass of a print cycle. FIG. 5B shows again the positions of the print head 26 in the four successive passes. Defective nozzles are again symbolized by black dots, operating nozzles are shown with a bold contour, and nozzles that are silent in FIG. 5A have a fainter contour. As in the previous example, the failure of nozzle No. 16 has created a missing line in line position F₁. In the previous example, this defect had been compensated by activating nozzle No. 13 in the second pass. This, however, is not possible in this example, because nozzle No. 13 is also failing. Still, the defect at line position F₁ can be compensated by printing an extra pixel line 36 with nozzle No. 7 in the fourth pass.

The failure of nozzle No. 13 has created another defect at a line position G₁ in the first pass. This defect can also be compensated in the fourth pass by printing an extra pixel line 38 with nozzle No. 4.

In the third pass, the nozzle failures have created defects at line positions F₃ and G₃, and these defects are compensated in the fourth pass by activating nozzles No. 14 and No. 11 so as to print extra pixel lines 40 and 42.

With the principle illustrated in FIGS. 4A-5B, it is possible to compensate even a larger number of nozzle failures by switching to the less productive four-pass mode, even though a two-pass mode would normally be sufficient for printing the image with the required quality, if there were no nozzle failures. However, it may depend upon the exact locations of the nozzle failures whether or not the failure can be compensated. In order to decide which nozzle failures can be compensated, an algorithm may be provided which analyses the relative positions of the failing and non-failing nozzles in the different passes as illustrated here in the diagrams in FIGS. 4B and 5B.

It will be understood that, in a practical embodiment, the number of nozzles 22 in the nozzle array will be significantly larger than in the simple examples shown here. For example, the number of nozzles may be several hundreds. Then, it is also possible to conceive of print modes with even more passes, e.g. a six-pass mode, an eight-pass mode and so on. The larger the number of passes, the lower will be the productivity of the print mode. When the analysis shows that the nozzle failures cannot be compensated satisfactorily in the print mode that had originally been selected, the print mode with the next lower productivity will be analyzed to see if a sufficient compensation of nozzle failures is possible with that mode.

FIGS. 6A-6C illustrate another strategy for nozzle failure compensation which can in some cases mitigate the loss in productivity. In the example shown, a nozzle failure occurs again at nozzle No. 16 in the 17-nozzle print head 26.

FIG. 6A shows a first pass of a print mode which is basically a two-pass mode. The nozzle failure leads to a defect at line position F₁.

FIG. 6B shows the second pass. However, the position of the recording medium 12 relative to the print head 26 has not been shifted by 8½ nozzle distances as in FIG. 3, but only by 6½ nozzle distances. Consequently, when the first pass of the next print cycle is performed, as shown in FIG. 6C, there is a certain overlap between the first passes in FIGS. 6A and 6C. Consequently, the nozzles No. 1 and No. 2 would normally be silent in the first pass.

Since the nozzle failure happens to be located within the overlap, it is possible to use one of the silent nozzles, nozzle No. 1 in this case, in order to compensate the defect. Thus, it is not necessary to switch to another print mode with a larger (integral) number of passes. Instead, the print mode is changed only by changing the media step size from 8.5 to 6.5 (in units of the nozzle-to-nozzle distance in the nozzle array).

It will be understood that the media step size may in principle be varied as desired in order to be able to compensate more nozzle failures, with the only limitation that the media step size has to match with the intended pixel raster.

In a certain sense, changing the media step size in order to create an overlap between corresponding passes can be considered to be equivalent to switching to a print mode with a non-integral number of passes. When n is the width of a swath (number of pixel lines of the swath) and m is the number of nozzles in the nozzle array that are actually used for printing, the “number of passes” may be defined as n/m. In the example shown in FIGS. 3A and 3B, n=34 and m=17 lead to n/m=2. In the example shown in FIGS. 6A-6C, two of the seventeen nozzles of the print head are silent because of the overlap, so that the effective number m of nozzles is only 15, which gives n/m=2.27. The surplus of 0.27 reflects the fact that there are some points on the recording medium (in the overlap) where the print head passes three times rather than twice in each cycle. When a single pass of the print head requires a fixed amount of time, the reciprocal of the number of passes (i.e. m/n) can also be taken as a measure of the productivity.

As is apparent from FIGS. 6A-6C, reducing the media step size will be helpful only for compensating nozzle failures near the ends of the nozzle array. It should be observed, however, that, in a multi-pass mode with a large number of passes, the overlaps accumulate from pass to pass, so that the possibilities to compensate nozzle failures even in the central part of the nozzle array increase significantly.

In the examples that have been described so far, the possibilities to compensate nozzle failures have been investigated independently of the actual content of the image to be printed. In other words, it has been assumed that the image to be printed is a solid area (such as the area 28 in FIG. 2A) with a 100% dot coverage. However, when the dot coverage is less than 100%, the likelihood that nozzle failures can be compensated so as to cause no visible defects in the printed image increases significantly.

FIGS. 7 and 8 illustrate an embodiment in which the image content is taken into account in the form of a sample image 44. In the example shown, the sample image 44 is a halftone image that may for example represent an image area with maximum dot coverage in an image to be printed. In case of color printing, separate sample images may be provided for each color.

The sample image 44 is composed of clusters or super pixels 46 each of which is constituted by a square matrix of 4×4 pixel. In the example shown, the dot coverage of the sample image is 50% so that eight out of the sixteen pixels in the matrix are actually to be printed. In accordance with well-known halftoning techniques, the pixel positions of the dots to be printed are randomly distributed over the matrix.

FIG. 7 further shows the positions of the print head 26 in two subsequent passes in a two-pass mode. The sample image 44 is constituted by a column of thirteen super pixels 46 covering the entire width of a swath of the image that is scanned by the print head 26 in the two passes (one print cycle).

Again, it is assumed that nozzle No. 13 and nozzle No. 16 of the print head 26 are failing. Horizontal lines 48 in FIG. 7 indicate the pixel lines in the sample image 44 that are affected by the nozzle failures. In the print mode that has been chosen here (two-pass mode with media step size 7½), the nozzle failures cannot be compensated by printing extra dots in the affected pixel lines.

However, since the exact positions of the ink dots within the super pixel 46 are not visible to the human eye and do not matter as long as the overall dot coverage of the super pixel is not changed, it is possible to compensate the nozzle failures by printing extra dots in the neighboring pixel lines, as has been shown in FIG. 8. Thus, the super pixels 46 that are affected by the nozzle failures, i.e. are “hit” by one of the lines 48, have a white pixel line, but the loss of dot coverage is compensated by extra black dots in one of the neighboring lines of the same super pixel (or an adjacent super pixel). In this example, full compensation of the nozzle failures is possible without any loss in productivity.

Of course, when the image to be printed has dark areas with a higher dot coverage, it will be necessary to use a sample image with larger dot coverage, and then it may not be possible to compensate all nozzle failures without changing to another print mode. Similarly, it may be necessary to change to another print mode when the number of nozzle failures in the print head 26 increases. For example, no failure compensation would be possible when nozzle failures occur for the three nozzles No. 4, No. 5 and No. 13.

The general steps of a method according to the invention are illustrated in a flow diagram in FIG. 9.

In Step S1, an initial print mode is selected from a list 50 of pre-defined print modes which are sorted by decreasing productivity. The selection may be based on quality settings made by the user.

In step S2, the printing of the sample image 44 is simulated in order to check whether all nozzle failures can be compensated or whether there remain any nozzle failures that cannot be compensated. It will be understood that the sample image may depend upon the properties of an image to be printed. If the image has an area of maximum dot coverage (per color), and this maximum dot coverage is 75%, for example, then the sample image 44 will also have a dot coverage of 75%.

Based on the simulation in step S2, the number of non-compensable nozzle failures is counted in step S3 and is checked against a given threshold value. If it is required that all nozzle failures are compensated, the threshold value will be zero. If a certain number of defects in the printed image can be tolerated, the threshold value may be higher.

When the threshold value is exceeded (N), it is checked in step S4 whether the end of the list 50 has been reached. If this is not the case (N), the next print mode in the list 50 is selected in step S5, and the process loops back to step S2 for simulating the print process again, but now with the less productive print mode that has been selected in step S5.

The loop comprising the steps S2, S3, S4 and S5 will be repeated until it is found in step S3 that the number of non-compensable nozzle failures is below the threshold value (Y) or it is found in step S4 that the end of the list 50 has been reached (Y).

In the first case, when the loop is exited in step S3, the process ends with step S6 where it is decided that the printer shall be switched to the print mode that had last been simulated in step S2.

If the loop is exited in step S4, the process branches to a step S7, where a print mode is selected from among all the print modes that have been simulated in step S2. From among these print modes, one print mode will be selected which has led to the lowest count of non-compensable nozzle failures in step S3, and then the printer will be switched to that print mode in step S6.

In a modified embodiment, the image content (sample image) is not taken into account in step S2, and the simulation is performed in the way that has been described in conjunction with FIGS. 2A to 6C.

Yet another embodiment is illustrated in FIG. 10. Here, the process starts with a step S10 of reading the image data of an image to be printed. The steps S11-S17 in FIG. 10 correspond to the step S1-S7 in FIG. 9, with the only difference that the simulation in step S12 is not based on a sample image but on the image that has been read in step S10. This simulation may be made for the entire image or for selected areas in the image which are considered to be particularly critical in terms of failure sensitivity.

1. A method of controlling a digital printer having a print head with an array of printing elements, the print head being arranged to scan a recording medium in a main scanning direction, and the print head and the recording medium being arranged to be moved relative to one another in a sub-scanning direction normal to the main scanning direction, the printer being arranged to operate in a selected one of a plurality of print modes which differ in productivity due to differences in a pattern of scan passes in which the array of printing elements moves over the recording medium, the printer further having a failure detection system arranged to detect malfunctioning printing elements, and a failure compensation system arranged to compensate a malfunction of a printing element by activating at least one other printing element in the array, the method comprising the steps of:
a) establishing a list of print modes sorted by decreasing productivity;
b) selecting an initial print mode;
c) simulating a print operation in the currently selected print mode;
d) counting a number of incidents in which a malfunction of a printing element cannot be compensated;
e) if the count result is below a given threshold value: keep the selected print mode;
f) if not: select the next print mode in the list and repeat steps (c) to (f) for that print mode.

2. The method according to claim 1, wherein the step (c) includes simulating a print operation in which an image with specific image content is printed.

3. The method according to claim 2, wherein the image used in the simulation in step (c) is a sample image.

4. The method according to claim 2, wherein the image used in the simulation in step (c) is at least a part of an image to be printed.

5. The method according to claim 1, wherein the list of print modes includes at least two print modes for which the number of scan passes that constitute a complete print cycle is equal and which differ in a size of a step by which the recording medium is advanced after each scan pass.

6. A digital printer having a print head with an array of printing elements, the print head being arranged to scan a recording medium in a main scanning direction, and the print head and the recording medium being arranged to be moved relative to one another in a sub-scanning direction normal to the main scanning direction, the printer being arranged to operate in a selected one of a plurality of print modes which differ in productivity due to differences in a pattern of scan passes in which the array of printing elements moves over the recording medium, the printer further having a processing system having an electronic processing unit arranged to control the movements of the print head and the recording medium as well as the operation of the printing elements, the processing system including a failure detection system arranged to detect malfunctioning printing elements, and a failure compensation system arranged to compensate a malfunction of a printing element by activating at least one other printing element in the array, wherein the processing unit is configured to control the printer in accordance with the method according to claim 1.

7. A software product comprising program code on a machine-readable medium, which program code, when loaded into an electronic processing unit of a digital printer, causes the processing unit to control the printer in accordance with the method according to claim 1.
